(19) United States
(12) Patent Application Publication
(10) Pub. No.: US 2019/0371236 A1
(43) Pub. Date: Dec. 5, 2019

(54) DISPLAY DEVICE, AND DRIVING METHOD OF PIXEL CIRCUIT OF DISPLAY DEVICE

(71) Applicant: Sharp Kabushiki Kaisha, Sakai-City, Osaka (JP)

(72) Inventor: Tamotsu SAKAI, Sakai City (JP)

(21) Appl. No.: 16/066,316

(22) PCT Filed: Mar. 24, 2017
(86) PCT No.: PCT/JP2017/011959

§ 371 Date: Jun. 27, 2018

(51) Int. Cl. G09G 3/3233; G09G 3/3266; G09G 3/3291

(52) U.S. Cl. CPC G09G 3/3233; G09G 3/3266; G09G 3/3291; G09G 2310/0286; G09G 2300/0439; G09G 2300/043; G09G 2300/0426

(57) ABSTRACT

To improve the performance with respect to moving pictures of an organic EL display device employing an internal compensation method for compensation processing to more than in the related art.

A pixel circuit is provided with an initialization transistor, the initialization transistor having a gate terminal connected to a corresponding scanning signal line in a row one or more rows previous, a source terminal connected to a gate terminal of a driving transistor, and a drain terminal connected to a corresponding initialization power source line. During a period in which a light emission control transistor in each of the pixel circuits is being kept on, a voltage for black display (Vini_H) is temporarily supplied to a corresponding initialization power source line instead of an initialization voltage (Vini_L), the voltage for black display (Vini_H) being a voltage at a level that turns the initialization transistor on and turns the driving transistor off.

### TECHNICAL FIELD

The following disclosure relates to a display device, and particularly relates to a display device employing a configuration that compensates for dispersions in threshold voltages of driving transistors and the like through an internal compensation method (a display device including an electro-optical element for current control), and to a driving method of a pixel circuit of the display device.

### BACKGROUND ART

An electro-optical element in which a luminance, transmittance, and the like are controlled by a voltage applied thereto, and an electro-optical element in which a luminance, transmittance, and the like are controlled by a current flowing therein, have been known available as display elements included in display devices. A liquid crystal display element can be given as a typical example of an electro-optical element in which the luminance, transmittance, and the like are controlled by a voltage applied thereto. On the other hand, an organic EL element can be given as a typical example of an electro-optical element in which the luminance, transmittance, and the like are controlled by a current flowing therein. Organic EL elements are also called Organic Light Emitting Diodes (OLEDs). With an organic EL display device that employs an organic EL element, which is a light emitting type electro-optical element, it is easier to achieve a thinner profile, lower power consumption, and higher luminance than with a liquid crystal display device which requires a backlight, color filters, and the like. Thus in recent years, organic EL display devices are being actively developed.

In organic EL display devices, thin film transistors (TFTs) are typically employed as driving transistors for controlling the supply of current to the organic EL elements. However, dispersions easily arise in the properties of thin film transistors. Specifically, it is easy for dispersions to arise in the threshold voltages. In a case where dispersions arise in the threshold voltages of the driving transistors provided within a display unit, dispersions in the luminance will arise as well, leading to a drop in the display quality. As such, various types of processing for compensating dispersions in the threshold voltages (compensation processing) have been proposed in the related art.

An internal compensation method that carries out compensation processing by providing capacitors for holding information of the threshold voltages of the driving transistors within the pixel circuits, and an external compensation method that carries out compensation processing by, for example, using a circuit provided outside of the pixel circuits to measure the amount of current flowing in the driving transistors under predetermined conditions and then correcting a video signal on the basis of the measurement results, are known as compensation processing methods. A configuration in which six p-channel thin film transistors T1 to T6 are used, as illustrated in FIG. 5, for example, is known as a configuration of a pixel circuit for an organic EL display device employing an internal compensation method for compensation processing. Additionally, J P 2010-26488 A, for example, discloses a configuration of a pixel circuit using seven p-channel thin film transistors.

### CITATION LIST

### Patent Literature

PTL 1: JP 2010-26488 A

### SUMMARY

### Technical Problem

Impulse driving, used in CRTs, for example, and hold driving, used in liquid crystal display devices, for example, are examples of display device driving methods. In a display device in which impulse driving is used, a lighting period in which an image is displayed and a light-out period in which an image is not displayed are repeated in an alternating manner. When displaying a moving picture, inserting light-out periods ensures that no afterimages of moving objects will be visible to a person viewing the image. As a result, the background and the object are clearly distinguished from each other, and the moving picture looks natural. However, in a display device in which hold driving is used, voltages corresponding to the image of each frame are written into the pixel circuits and are then held until the next time those voltages are rewritten. The image of a given frame is thus close, in terms of time, to the image of the previous frame. Consequently, afterimages of moving objects will be visible to a person viewing the image when a moving picture is displayed. As such, display devices employing hold driving as the driving method have insufficient performance with respect to moving pictures. Hold driving is used in the organic EL display device having pixel circuits configured as illustrated in FIG. 5, which uses p-channel thin film transistors. Thus, the organic EL display device also has insufficient performance with respect to moving pictures.

Accordingly, an object of the following disclosure is to improve the performance with respect to moving pictures of an organic EL display device employing an internal compensation method for compensation processing more than in the related art.

### Solution to Problem

A display device according to some embodiments includes a plurality of data lines, a plurality of scanning signal lines arranged intersecting with the plurality of data lines, a plurality of pixel circuits provided corresponding to points of intersection of the plurality of data lines and the plurality of scanning signal lines and forming a pixel matrix having a plurality of rows and a plurality of columns, a plurality of light emission control lines provided corresponding one-to-one with the plurality of scanning signal lines, a first power source line through which a high-level voltage is supplied, and a second power source line through which a low-level voltage is supplied, the display device further including a plurality of initialization power source lines through which an initialization voltage for initializing the plurality of pixel circuits is supplied, and an initialization power source line driving unit configured to drive the plurality of initialization power source lines. Each of the plurality of pixel circuits includes: a control node; an electro-optical element, the electro-optical element being provided between the first power source line and the second power source line; a driving transistor, the driving transistor including a control terminal connected to the control node and being provided between the first power source line and the second power source line in series with the electro-optical element; a write control transistor, the write control transistor including a control terminal connected to a corresponding scanning signal line and configured to supply, to the control node, a voltage based on a data signal supplied to the corresponding data line; a light emission control transistor, the light emission control transistor including a control terminal connected to a corresponding light emission control line and being provided between the first power source line and the second power source line in series with the electro-optical element and the driving transistor; a capacitance element configured to hold a charge based on a voltage at the control node; and an initialization transistor, the initialization transistor being provided between a corresponding initialization power source line and the control node. During a period in which the light emission control transistor in each of the pixel circuits is being kept on, the initialization power source line driving unit is configured to temporarily supply, to a corresponding initialization power source line, a voltage for black display instead of the initialization voltage, the voltage for black display being a voltage at a level that turns the initialization transistor on and turns the driving transistor off.

Additionally, a driving method according to some embodiments (a driving method for a pixel circuit of a display device) includes: supplying the initialization voltage to the control node by supplying an on-level voltage to the scanning signal line connected to the control terminal of the initialization transistor and turning the initialization transistor on; supplying, to the control node, a voltage based on a data signal supplied to a corresponding data line, by supplying an on-level voltage to a corresponding scanning signal line and turning the write control transistor on; causing the electro-optical element to emit light by supplying an on-level voltage to a corresponding light emission control line and turning the light emission control transistor on; and during a period in which the light emission control transistor is being kept on, temporarily supplying, to a corresponding initialization power source line, a voltage for black display instead of the initialization voltage, the voltage for black display being a voltage at a level that turns the initialization transistor on and turns the driving transistor off.

### Advantageous Effects of Disclosure

During a period in which the light emission control transistor in each of the pixel circuits is being kept on, the voltage for black display is temporarily supplied to the corresponding initialization power source line instead of the initialization voltage, the voltage for black display being a voltage at a level that turns the initialization transistor on and turns the driving transistor off. In other words, the driving transistor is turned off after a predetermined period has passed after the electro-optical element in each pixel circuit has started emitting light. Through this, the supply of drive current to the electro-optical element is stopped, and the electro-optical element is extinguished. In this manner, black insertion (inserting a black display between the image display for a given frame and the image display for the frame following thereafter) is carried out, and thus a light emitting period and a light-out period (a black insertion period) are repeated in an alternating manner in each pixel circuit. In this manner, simulated impulse driving is carried out, which improves the moving picture performance compared to the related art.

### BRIEF DESCRIPTION OF DRAWINGS

FIG. 1 is a timing chart illustrating a driving method of an organic EL display device according to a first embodiment.

FIG. 2 is a block diagram illustrating the overall configuration of the organic EL display device according to the first embodiment.

FIG. 3 is a block diagram illustrating the configuration of an initialization driver according to the first embodiment.

FIG. 4 is a circuit diagram illustrating an example of the configuration of a selection circuit according to the first embodiment.

FIG. 5 is a circuit diagram illustrating the configuration of a pixel circuit corresponding to an mth column and an nth row according to the first embodiment.

FIG. 6 is a timing chart illustrating a driving method of a pixel circuit according to the first embodiment.

FIG. 7 is a diagram illustrating actions when voltage for black display is applied to an initialization power source line according to the first embodiment.

FIG. 8 is a diagram illustrating a duration of a black insertion period according to the first embodiment.

FIG. 9 is a diagram illustrating transitions between light emitting periods and light-out periods according to the first embodiment, focusing on individual pixel circuits.

FIG. 10 is a diagram illustrating transitions between light emitting periods and light-out periods according to the first embodiment, as a whole.

FIG. 11 is a circuit diagram illustrating a configuration of a pixel circuit corresponding to an mth column and an nth row according to a modification of the first embodiment.

FIG. 12 is a block diagram illustrating the configuration of an initialization driver and grouping of initialization power source lines according to a second embodiment.

FIG. 13 is a timing chart illustrating a driving method according to the second embodiment.

FIG. 14 is a diagram illustrating transitions between light emitting periods and light-out periods according to the second embodiment, as a whole.

FIG. 15 is a diagram illustrating an example of the configuration of initialization power source lines according to a modification of the second embodiment.

FIG. 16 is a diagram illustrating another example of the configuration of initialization power source lines according to a modification of the second embodiment.

FIG. 17 is a diagram illustrating yet another example of the configuration of initialization power source lines according to a modification of the second embodiment.

FIG. 18 is a timing chart illustrating driving method according to a modification of the second embodiment.

FIG. 19 is a diagram illustrating transitions between light emitting periods and light-out periods according to a modification of the second embodiment, as a whole.

### DESCRIPTION OF EMBODIMENTS

Embodiments will be described hereinafter with reference to the appended drawings. Note that in the following, it is assumed that i and j are integers of 2 or greater; m is an integer of 1 or greater and i or lower; and n is an integer of 1 or greater and j or lower.

### 1. First Embodiment

### 1.1 Overall Configuration

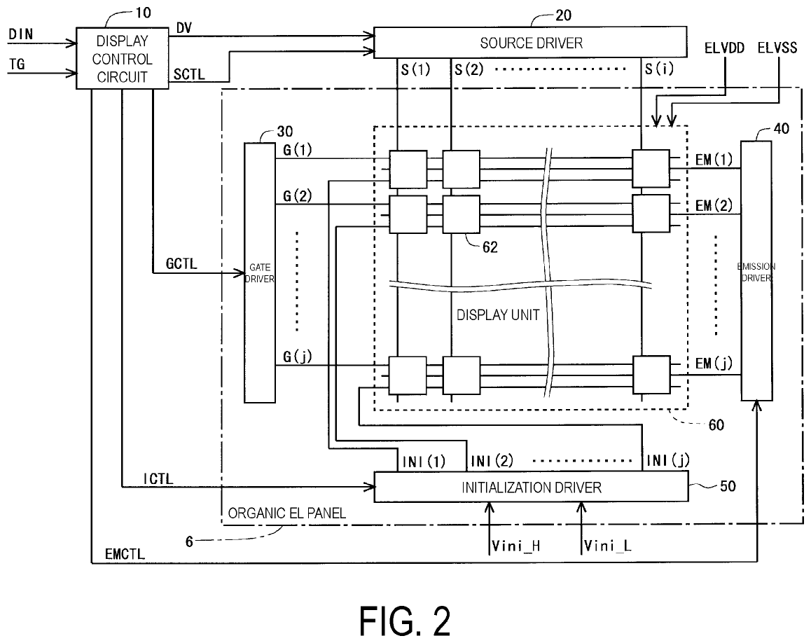

FIG. 2 is a block diagram illustrating the overall configuration of an organic EL display device according to a first embodiment. This organic EL display device includes a display control circuit 10, a source driver 20, a gate driver 30, an emission driver 40, an initialization driver (initialization power source line driving section) 50, and a display unit 60. Note that in the present embodiment, the gate driver 30, the emission driver 40, and the initialization driver 50 are formed within an organic EL panel 6 that includes the display unit 60. In other words, the gate driver 30, the emission driver 40, and the initialization driver 50 are monolithic. However, a configuration in which these elements are not monolithic can also be employed.

i data lines S(1) to S(i), and j scanning signal lines G(1) to G(j) orthogonal thereto, are arranged in the display unit 60. j light emission control lines EM(1) to EM(j) are also arranged in the display unit 60, corresponding one-to-one with the j scanning signal lines G(1) to G(j). Furthermore, in the present embodiment, j initialization power source lines INI(1) to INI(j) are arranged in the display unit 60, corresponding one-to-one with the j scanning signal lines G(1) to G(j). In the display unit 60, the scanning signal lines G(1) to G(j), the light emission control lines EM(1) to EM(j), and the initialization power source lines INI(1) to INI(j) are typically parallel to each other. i×j pixel circuits 62 are provided in the display unit 60, corresponding to points of intersection of the i data lines S(1) to S(i) and the j scanning signal lines G(1) to G(j). A pixel matrix of i columns×j rows is formed in the display unit 60 by providing the i×j pixel circuits 62 in this manner. Note that in the following, signs G(1) to G(j) are also appended to scanning signals supplied to the j scanning signal lines G(1) to G(j), respectively; signs EM(1) to EM(j) are also appended to light emission control signals supplied to the j light emission control lines EM(1) to EM(j), respectively; signs INI(1) to INI(j) are also appended to initialization signals supplied to the j initialization power source lines INI(1) to INI(j), respectively; and signs S(1) to S(i) are also appended to data signals supplied to the data lines S(1) to S(i), respectively.

Power source lines (not illustrated) are provided in the display unit 60 in common for the pixel circuits 62. More specifically, a power source line supplying a high-level power source voltage ELVDD for driving organic EL elements (called a “high-level power source line” hereinafter) and a power source line supplying a low-level power source voltage ELVSS for driving the organic EL elements (called a “low-level power source line” hereinafter) are provided. The high-level power source voltage ELVDD and the low-level power source voltage ELVSS are supplied from a power source circuit, which is not illustrated. In the present embodiment, a first power source line is realized by the high-level power source line, and a second power source line is realized by the low-level power source line.

Actions of the various constituent elements illustrated in FIG. 2 will be described next. The display control circuit 10 receives an input image signal DIN and a timing signal group (a horizontal synchronization signal, a vertical synchronization signal, and the like) TG from outside, and outputs a digital video signal DV, a source control signal SCTL that controls actions of the source driver 20, a gate control signal GCTL that controls actions of the gate driver 30, an emission driver control signal EMCTL that controls actions of the emission driver 40, and an initialization driver control signal ICTL that controls actions of the initialization driver 50. The source control signal SCTL contains a start pulse signal (source start pulse signal), a clock signal (source clock signal), a latch strobe signal, and the like. The gate control signal GCTL, the emission driver control signal EMCTL, and the initialization driver control signal ICTL each contain a start pulse signal and a clock signal.

The source driver 20 is connected to the i data lines S(1) to S(i). The source driver 20 receives the digital video signal DV and the source control signal SCTL outputted from the display control circuit 10, and applies data signals to the i data lines S(1) to S(i). The source driver 20 includes an i-bit shift register, a sampling circuit, a latch circuit, i D/A converters, and the like, which are not illustrated. The shift register includes i cascade-connected registers. The shift register transfers the pulse of the source start pulse signal supplied to the first-stage register sequentially from an input end to an output end, on the basis of the source clock signal. As this pulse is transferred, sampling pulses are outputted from each stage of the shift register. The sampling circuit stores the digital video signal DV on the basis of the sampling pulses. The latch circuit acquires and holds one row of the digital video signal DV, stored in the sampling circuit, in accordance with the latch strobe signal. The D/A converters are provided corresponding to the data lines S(1) to S(i). The D/A converter convert the digital video signal DV held in the latch circuit into an analog voltage. The analog voltage resulting from the conversion is applied to all of the data lines S(1) to S(i) at once as a data signal.

The gate driver 30 is connected to the j scanning signal lines G(1) to G(j). The gate driver 30 includes a shift register, a logic circuit, and the like. The gate driver 30 drives the j scanning signal lines G(1) to G(j) on the basis of the gate control signal GCTL outputted from the display control circuit 10.

The emission driver 40 is connected to the j light emission control lines EM(1) to EM(j). The emission driver 40 includes a shift register, a logic circuit, and the like. The emission driver 40 drives the j light emission control lines EM(1) to EM(j) on the basis of the emission driver control signal EMCTL outputted from the display control circuit 10.

The initialization driver 50 is connected to the j initialization power source lines INI(1) to INI(j). The initialization driver 50 drives the j initialization power source lines INI(1) to INI(j) on the basis of the initialization driver control signal ICTL outputted from the display control circuit 10. Here, an initialization voltage Vini_L, which is a comparatively low-level voltage for initializing the pixel circuits 62, and a voltage for black display Vini_H, which is a comparatively high-level voltage for carrying out a black insertion, described later (inserting a black display between the image display for a given frame and the image display for the frame following thereafter), are supplied to the initialization driver 50, and the voltage supplied to the j initialization power source lines INI(1) to INI(j) is either the initialization voltage Vini_L or the voltage for black display Vini_H. The initialization driver 50 will be described in detail later.

In this manner, an image based on the input image signal DIN is displayed in the display unit 60 by driving the i data lines S(1) to S(i), the j scanning signal lines G(1) to G(j), the j light emission control lines EM(1) to EM(j), and the j initialization power source lines INI(1) to INI(j).

### 1.2 Initialization Driver

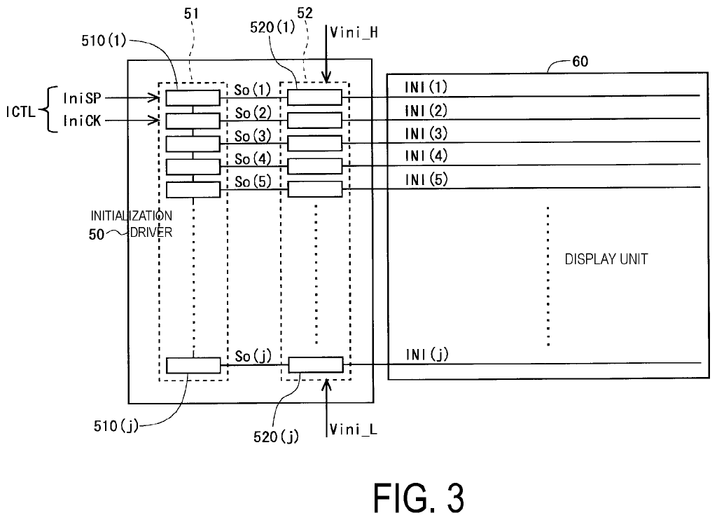

FIG. 3 is a block diagram illustrating a configuration of the initialization driver 50 according to the present embodiment. As illustrated in FIG. 3, the initialization driver 50 includes a shift register 51 including j stages (j unit circuits 510(1) to 510(j)) and a selection circuit group 52 including j selection circuits 520(1) to 520(j). Output signals So(1) to So(j), outputted from the unit circuits 510(1) to 510(j), are supplied to corresponding ones of the selection circuits 520(1) to 520(j). Note that the output signals So(1) to So(j) are low-level most of the time. The selection circuits 520(1) to 520(j) are connected to corresponding ones of the initialization power source lines INI(1) to INI(j).

In the configuration described above, an initialization start pulse signal IniSP and an initialization clock signal IniCK are inputted to the shift register 51 as the initialization driver control signal ICTL. The shift register 51 sequentially transfers the pulse of the initialization start pulse signal IniSP from the unit circuit 510(1) in the first stage to the unit circuit 510(j) in the jth stage on the basis of the initialization clock signal IniCK. In response to this pulse transfer, the output signals So(1) to So(j) outputted from the shift register 51 in each stage (the unit circuits 510(1) to 510(j)) go to high level in sequence every predetermined period.

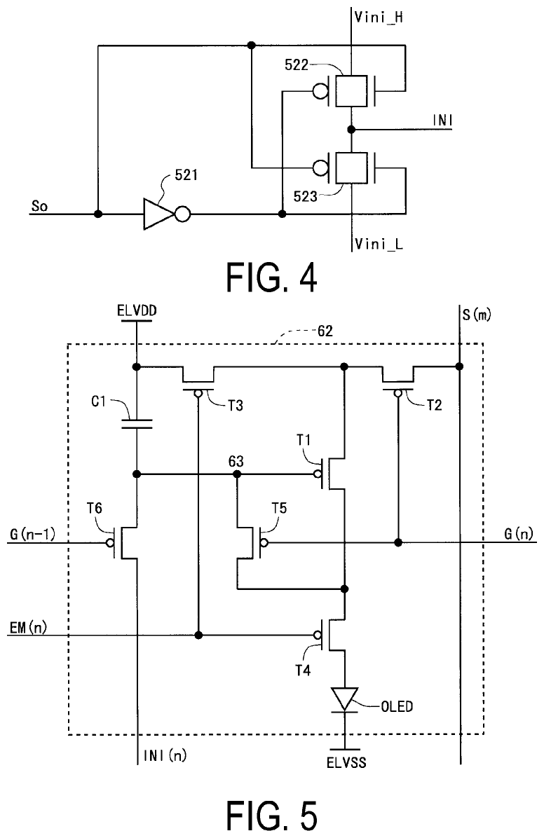

FIG. 4 is a circuit diagram illustrating an example of the configuration of the selection circuit 520. The selection circuit 520 includes an inverter 521 and two CMOS switches 522 and 523. The output signal So is supplied to an input terminal of the inverter 521, and an output terminal of the inverter 521 is connected to a gate terminal of a p-channel transistor of the CMOS switch 522 and a gate terminal of an n-channel transistor of the CMOS switch 523. The voltage for black display Vini_H is supplied to an input terminal of the CMOS switch 522, and an output terminal of the CMOS switch 522 is connected to the initialization power source line INI. The output signal So is supplied to a gate terminal of an n-channel transistor of the CMOS switch 522, and a logical inversion signal of the output signal So is supplied to the gate terminal of the p-channel transistor of the CMOS switch 522. The initialization voltage Vini_L is supplied to an input terminal of the CMOS switch 523, and an output terminal of the CMOS switch 523 is connected to the initialization power source line INI. A logical inversion signal of the output signal So is supplied to the gate terminal of the n-channel transistor of the CMOS switch 523, and the output signal So is supplied to the gate terminal of the p-channel transistor of the CMOS switch 523. According to this configuration, when the output signal So is high level, the CMOS switch 522 is on and the CMOS switch 523 is off, and the voltage for black display Vini_H is supplied to the initialization power source line INI as the initialization signal. On the other hand, when the output signal So is low level, the CMOS switch 522 is off and the CMOS switch 523 is on, and thus the initialization voltage Vini_L is supplied to the initialization power source line INI as the initialization signal.

With the selection circuit 520 configured as illustrated in FIG. 4, each of the output signals So(1) to So(j) supplied to the selection circuits 520(1) to 520(j) sequentially goes to high level every predetermined period, as described above. Accordingly, the voltage for black display (a comparatively high-level voltage) Vini_H is supplied sequentially, every predetermined period, to the initialization power source lines INI(1) to INI(j), which are supplied with the initialization voltage (a comparatively low-level voltage) Vini_L most of the time.

The configuration of the initialization driver 50 described here is merely an example, and is not particularly limited as long as the voltage for black display Vini_H can be temporarily supplied sequentially, one line at a time, to the initialization power source lines INI(1) to INI(j) to which the initialization voltage Vini_L is being supplied.

### 1.3 Configuration of Pixel Circuits

The configuration and actions of the pixel circuits 62 in the display unit 60 will be described next. FIG. 5 is a circuit diagram illustrating the configuration of the pixel circuit 62 corresponding to the mth column and the nth row. The pixel circuit 62 illustrated in FIG. 5 includes one organic EL element OLED, six transistors T1 to T6 (a driving transistor T1, a write control transistor T2, a power supply control transistor T3, a light emission control transistor T4, a threshold voltage compensation transistor T5, and an initialization transistor T6), and one capacitor C1. The transistors T1 to T6 are p-channel thin film transistors. The capacitor C1 is a capacitance element including two electrodes (a first electrode and a second electrode).

With p-channel transistors, whichever of the drain and source has the higher potential is typically referred to as the source, but the following descriptions define one as the drain and the other as the source, and thus the drain potential may be higher than the source potential.

Additionally, the gate terminal of the driving transistor T1, the drain terminal of the threshold voltage compensation transistor T5, the source terminal of the initialization transistor T6, and the second electrode of the capacitor C1 are connected to each other, as illustrated in FIG. 5, and the region (lines) where these elements are connected to each other is referred to as “control node” here. The control node is indicated by the reference numeral 63.

With respect to the driving transistor T1, the gate terminal is connected to the control node 63, the source terminal is connected to the drain terminal of the write control transistor T2 and the drain terminal of the power supply control transistor T3, and the drain terminal is connected to the source terminal of the light emission control transistor T4 and the source terminal of the threshold voltage compensation transistor T5. With respect to the write control transistor T2, the gate terminal is connected to the scanning signal line G(n) in the nth row, the source terminal is connected to the data line S(m) in the mth column, and the drain terminal is connected to the source terminal of the driving transistor T1 and the drain terminal of the power supply control transistor T3. With respect to the power supply control transistor T3, the gate terminal is connected to the light emission control line EM(n) in the nth row, the source terminal is connected to the high-level power source line and the first electrode of the capacitor C1, and the drain terminal is connected to the source terminal of the driving transistor T1 and the drain terminal of the write control transistor T2.

With respect to the light emission control transistor T4, the gate terminal is connected to the light emission control line EM(n) in the nth row, the source terminal is connected to the drain terminal of the driving transistor T1 and the source terminal of the threshold voltage compensation transistor T5, and the drain terminal is connected to the anode terminal of the organic EL element OLED. With respect to the threshold voltage compensation transistor T5, the gate terminal is connected to the scanning signal line G(n) in the nth row, the source terminal is connected to the drain terminal of the driving transistor T1 and the source terminal of the light emission control transistor T4, and the drain terminal is connected to the control node 63. With respect to the initialization transistor T6, the gate terminal is connected to the scanning signal line G(n−1) in the (n−1)th row, the source terminal is connected to the control node 63, and the drain terminal is connected to the initialization power source line INI(n).

With respect to the capacitor C1, the first electrode is connected to the high-level power source line and the source terminal of the power supply control transistor T3, and the second electrode is connected to the control node 63. With respect to the organic EL element OLED, the anode terminal is connected to the drain terminal of the light emission control transistor T4, and the cathode terminal is connected to the low-level power source line.

Note that for each of the transistors T1 to T6, the gate terminal corresponds to a control terminal, the source terminal corresponds to a first conduction terminal, and the drain terminal corresponds to a second conduction terminal.

### 1.4 Driving Method

A driving method according to the present embodiment will be described next.

### 1.4.1 Actions of Pixel Circuits

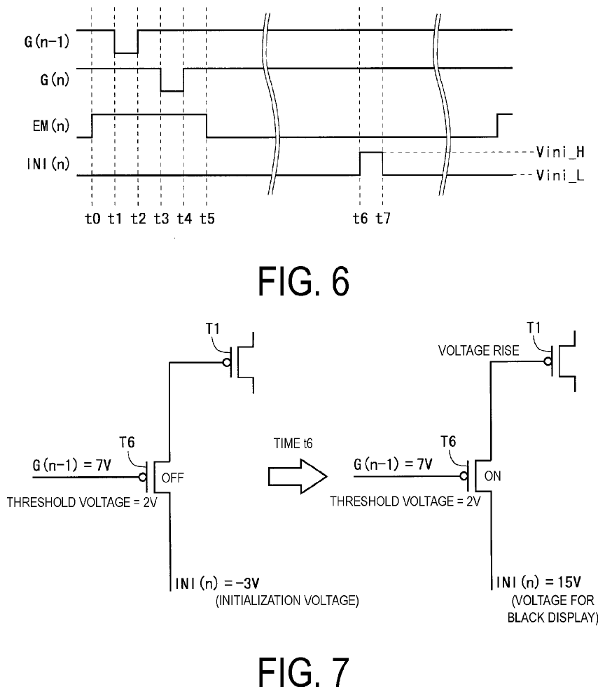

Actions of the pixel circuits 62 will be focused on first. FIG. 6 is a timing chart for illustrating the driving method with respect to the pixel circuit 62 corresponding to the mth column and the nth row. Prior to time t0, the scanning signal G(n−1) and the scanning signal G(n) are at high level, and the light emission control signal EM(n) is at low level. Additionally, the initialization signal INI(n) is at low level. In other words, the initialization voltage Vini_L is supplied to the initialization power source line INI(n). The light emission control transistor T4 is on at this time.

At time t0, the light emission control signal EM(n) changes from low level to high level. The light emission control transistor T4 turns off as a result. At time t1, the scanning signal G(n−1) changes from high level to low level. The initialization transistor T6 turns on as a result. Accordingly, a gate voltage of the driving transistor T1 (a voltage at the control node 63) is initialized, on the basis of the initialization voltage Vini_L supplied to the drain terminal of the initialization transistor T6 as the initialization signal INI. At time t2, the scanning signal G(n−1) changes from low level to high level. The initialization transistor T6 turns off as a result.

At time t3, the scanning signal G(n) changes from high level to low level. The write control transistor T2 and the threshold voltage compensation transistor T5 turn on as a result. Accordingly, the data signal S(m) is supplied to the gate terminal of the driving transistor T1 (the control node 63) via the write control transistor T2, the driving transistor T1, and the threshold voltage compensation transistor T5. The capacitor C1 is charged, and a gate voltage Vg of the driving transistor T1 has a magnitude expressed by Equation (1) below.

Vg=Vdata−Vth (1)

Here, Vdata represents a data voltage (the voltage of the data signal S(m)), and Vth represents a threshold voltage of the driving transistor T1 (an absolute value).

At time t4, the scanning signal G(n) changes from low level to high level. The write control transistor T2 and the threshold voltage compensation transistor T5 turn off as a result. At time t5, the light emission control signal EM(n) changes from high level to low level. The power supply control transistor T3 and the light emission control transistor T4 turn on as a result. Accordingly, a drive current I of a magnitude expressed by Equation (2) is supplied to the organic EL element OLED, and the organic EL element OLED emits light in accordance with the magnitude of the drive current I.

I=(β/2)·(Vgs−Vth)2 (2)

Here, β represents a constant, and Vgs represents a source-gate voltage of the driving transistor T1.

The source-gate voltage Vgs of the driving transistor T1 is expressed by Equation (3) below.

$$Vgs = ELVDD - Vg = ELVDD - V data + V th \qquad ( 3 )$$

Substituting Equation (3) in Equation (2) gives Equation (4) below.

I=β/2·(ELVDD−Vdata)² (4)

Equation (4) does not contain a term for the threshold voltage Vth. In other words, the drive current I according to the magnitude of the data voltage is supplied to the organic EL element OLED regardless of the magnitude of the threshold voltage Vth of the driving transistor T1. Dispersions in the threshold voltage Vth of the driving transistors T1 are thus compensated.

At time t6, the initialization signal INI(n) changes from low level to high level. In other words, the voltage for black display Vini_H is supplied to the initialization power source line INI(n). Here, the voltage for black display Vini_H is set so that a difference between the voltage for black display Vini_H and a high-level voltage of the scanning signal G is greater than a threshold voltage of the initialization transistor T6. To rephrase, the voltage for black display Vini_H is set so that Equation (5) below holds true.

Vini_H>VH_G+Vth(T6) (5)

Here, VH_G represents the high-level voltage of the scanning signal G, and Vth(T6) represents the threshold voltage of the initialization transistor T6.

A specific example of this will be described with reference to FIG. 7. In the example illustrated in FIG. 7, the threshold voltage Vth(T6) of the initialization transistor T6 is 2 V, and the high-level voltage of the scanning signal G is set to 7 V. The initialization transistor T6 is a p-channel transistor, and thus the initialization transistor T6 turns on when the gate voltage thereof is lower than the source/drain voltage by 2 V or greater. Thus, the initialization voltage Vini_L is set to −3 V so that the initialization transistor T6 is kept off most of the time. Here, the voltage for black display Vini_H is set to 15 V, and the initialization transistor T6 turns on at the aforementioned time t6 in response to the drain voltage of the initialization transistor T6 rising. The gate voltage of the driving transistor T1 rises as a result. Note that a low-level voltage of the scanning signal G is set to −7 V, and the initialization transistor T6 turns on at the aforementioned time t1 in response to the gate voltage of the initialization transistor T6 dropping. The gate voltage of the driving transistor T1 is initialized on the basis of the initialization voltage Vini_L as a result.

As described above, the initialization transistor T6 turns on at time t6 in response to the voltage for black display Vini_H being set so that Equation (6) above holds true. Accordingly, the voltage for black display Vini_H is supplied to the gate terminal of the driving transistor T1 and the driving transistor T1 turns off. As a result, the supply of the drive current I to the organic EL element OLED stops and the organic EL element OLED is extinguished.

At time t7, the initialization signal INI(n) changes from high level to low level. In other words, the initialization voltage Vini_L is supplied to the initialization power source line INI(n). The initialization transistor T6 turns off as a result. At this time, the gate voltage of the driving transistor T1 is maintained, and thus the driving transistor T1 is kept off. Accordingly, the organic EL element OLED is kept extinguished from time t7 onward as well. To be more specific, the organic EL element OLED is kept extinguished until that organic EL element OLED emits light again in response to the above-described actions from time t0 to t5 being carried out for the next frame.

As described above, the voltage for black display Vini_H is supplied to the initialization power source line INI(n) instead of the initialization voltage Vini_L in a period corresponding to part of each frame period (the period from time t6 to t7, in the example illustrated in FIG. 6), i.e. temporarily. The organic EL element OLED is kept extinguished from when the voltage for black display Vini_H is supplied to the initialization power source line INI(n) until the actions for light emission in the next frame are carried out.

A black display is therefore performed in pixels where the organic EL element OLEDs are extinguished. Accordingly, a black insertion is performed by driving the pixel circuits 62 as described above. In the following, a period in which, when focusing on the pixel circuits 62, the organic EL element OLED is emitting light will be called a “light emitting period”, and a period in which the organic EL element OLED is extinguished due to black insertion will be called a “black insertion period”.

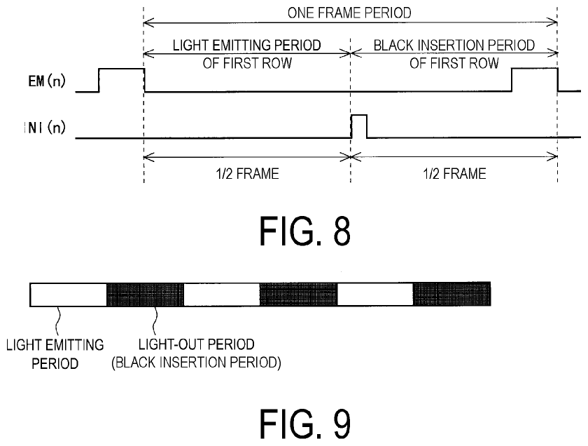

A black insertion period having an adequate duration is necessary in order to achieve adequate moving picture performance. For example, it is thought that in a case where the driving frequency is 60 Hz, a duration longer than or equal to 50% of a single frame period is preferable for the black insertion period. However, a longer black insertion period results in decreased luminance, and it is thus preferable that the duration of the black insertion period be adjusted as needed. For example, in the case where a duration equivalent to 50% of a single frame period is used as the black insertion period, it is preferable that the voltage for black display Vini_H be supplied to the initialization power source line INI(n) upon a period equivalent to ½ the duration of a single frame period passing after the point in time when the light emission control signal EM(n) changes from high level to low level (i.e. the point in time when the light emitting period starts), as illustrated in FIG. 8.

Note that in the present embodiment, a step of initializing is realized by the actions from time t1 to t2, a step of charging is realized by the actions from time t3 to t4, a step of emitting light is realized by the actions from time t5 to t6, and a step of applying voltage for black display is realized by the actions from time t6 to t7.

### 1.4.2 Overall Actions

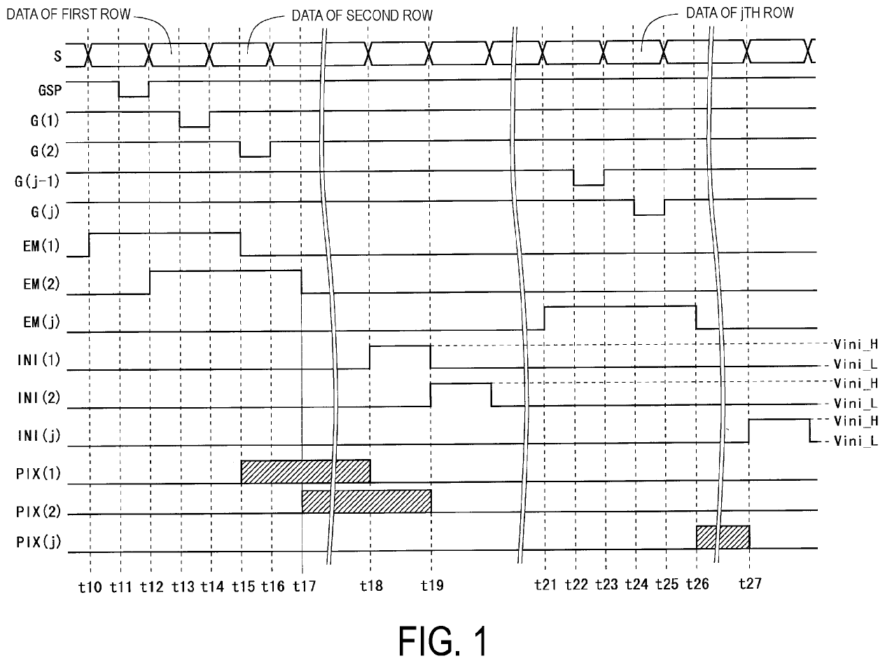

Next, overall actions will be described with reference to the timing chart illustrated in FIG. 1, in light of the above-described actions of the pixel circuits 62. After the light emission control signal EM(1) has changed from low level to high level at time t10, a gate start pulse signal GSP changes from high level to low level at time t11. The gate start pulse signal GSP is supplied to the gate terminal of the initialization transistor T6 in each of the pixel circuits 62 in the first row. The gate voltage of the driving transistor T1 (the voltage at the control node 63) in each of the pixel circuits 62 in the first row are initialized as a result.

After the light emission control signal EM(2) has changed from low level to high level at time t12, the scanning signal G(1) changes from high level to low level at time t13. The gate voltage of the driving transistor T1 (the voltage at the control node 63) in each of the pixel circuits 62 in the second row are initialized as a result. Additionally, the data signal S(m) is supplied to the gate terminal of the driving transistor T1 in each of the pixel circuits 62 in the first row.

After the scanning signal G(1) has changed from low level to high level at time t14, the light emission control signal EM(1) changes from high level to low level at time t15. As a result, in each of the pixel circuits 62 in the first row, the drive current is supplied to the organic EL element OLED and the organic EL element OLED emits light in accordance with the magnitude of the drive current. At time t15, the scanning signal G(2) changes from high level to low level. As a result, the gate voltage of the driving transistor T1 (the voltage of the control node 63) are initialized in each of the pixel circuits 62 in the third row, and the data signal S(m) is supplied to the gate terminal of the driving transistor T1 in each of the pixel circuits 62 in the second row.

After the scanning signal G(2) has changed from low level to high level at time t16, the light emission control signal EM(2) changes from high level to low level at time t17. As a result, in each of the pixel circuits 62 in the second row, the drive current is supplied to the organic EL element OLED and the organic EL element OLED emits light in accordance with the magnitude of the drive current.

In this manner, the organic EL element OLEDs emit light one row at a time in sequence. Note that in the columns indicated by PIX(1), PIX(2), and PIX(j) in FIG. 1, the light emitting periods of the organic EL element OLEDs included in the pixel circuits 62 in the first, second, and jth rows are indicated by hatched rectangles.

Thereafter, the voltage for black display Vini_H is supplied to the initialization power source line INI(1) at time t18. As a result, in each of the pixel circuits 62 in the first row, the driving transistor T1 turns off, the supply of the drive current to the organic EL element OLED stops, and the organic EL element OLED is extinguished. Likewise, at time t19, the voltage for black display Vini_H is supplied to the initialization power source line INI(2), and the organic EL element OLEDs in each of the pixel circuits 62 in the second row are extinguished.

Then, after the light emission control signal EM(j) has changed from low level to high level at time t21, the scanning signal G(j−1) changes from high level to low level at time t22. The gate voltage of the driving transistor T1 (the voltage at the control node 63) in each of the pixel circuits 62 in the jth row are initialized as a result.

After the scanning signal G(j−1) has changed from low level to high level at time t23, the scanning signal G(j) changes from high level to low level at time t24. As a result, the data signal S(m) is supplied to the gate terminal of the driving transistor T1 in each of the pixel circuits 62 in the jth row.

After the scanning signal G(j) has changed from low level to high level at time t25, the light emission control signal EM(j) changes from high level to low level at time t26. As a result, in each of the pixel circuits 62 in the jth row, the drive current is supplied to the organic EL element OLED, and the organic EL element OLED emits light in accordance with the magnitude of the drive current.

Thereafter, the voltage for black display Vini_H is supplied to the initialization power source line INI(j) at time t27. As a result, in each of the pixel circuits 62 in the jth row, the driving transistor T1 turns off, the supply of the drive current to the organic EL element OLED stops, and the organic EL element OLED is extinguished.

In this manner, the organic EL element OLEDs emit light one row at a time in sequence, and the organic EL element OLEDs are extinguished one row at a time in sequence. Through this, a black insertion period of the same duration is provided in all of the rows.

Although the timing at which the light emission control signal EM(j) changes from low level to high level is later than the timing at which the initialization signal INI(1) changes from low level to high level in the example illustrated in FIG. 1, the timing is not limited thereto. The timing at which the light emission control signal EM(j) changes from low level to high level may be earlier than the timing at which the initialization signal INI(1) changes from low level to high level.

### 1.5 Effects

According to the present embodiment, once a predetermined period has passed from when the organic EL element OLED in the pixel circuit 62 has started emitting light at a luminance based on the data signal S, the voltage at the initialization power source line INI corresponding to that pixel circuit 62 is increased from the initialization voltage Vini_L, which is a comparatively low-level voltage, to the voltage for black display Vini_H, which is a comparatively high-level voltage, in order to initialize the pixel circuit 62. The voltage for black display Vini_H is set so that a difference between the voltage for black display Vini_H and the high-level voltage of the scanning signal G(n) is greater than the threshold voltage of the initialization transistor T6. Accordingly, the initialization transistor T6 reliably turns on when the voltage for black display Vini_H is applied to the initialization power source line INI, and the voltage for black display Vini_H is supplied to the gate terminal of the driving transistor T1. The driving transistor T1 thus turns off, and as a result, the supply of the drive current to the organic EL element OLED stops and the organic EL element OLED is extinguished. In this manner, a black display period is inserted in each frame period. In other words, in each of the pixel circuits 62, a light emitting period and a light-out period (a black insertion period) are repeated in an alternating manner, as illustrated in FIG. 9. In this manner, simulated impulse driving is carried out, which improves the moving picture performance compared to the related art. Thus, according to the present embodiment, moving picture performance can be improved move than in the related art in an organic EL display device having a configuration including pixel circuits 62 having six transistors (p-channel thin film transistors), in which an internal compensation method is employed for compensation processing that compensates for the threshold voltage of the driving transistor T1. Here, in each of the pixel circuits 62, the voltage for black display Vini_H is applied to the initialization power source line INI so that the organic EL element OLED stops emitting light throughout a period ½ or more than a single frame period, which provides a light-out period (black insertion period) of an adequate duration between the light emitting period and the light emitting period, and thus achieves adequate moving picture performance.

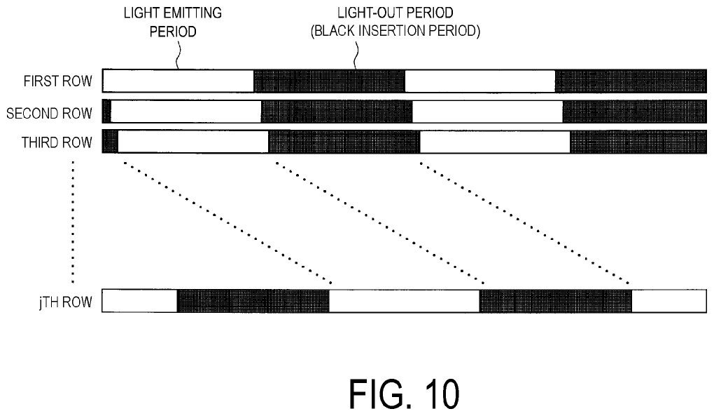

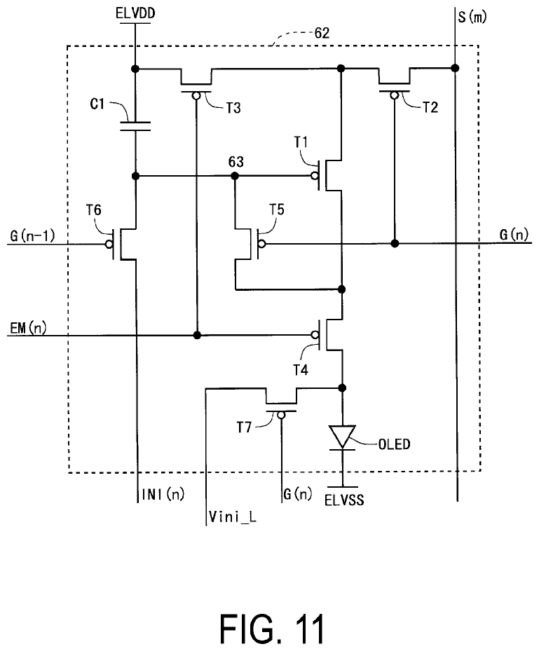

Additionally, in the present embodiment, control of the initialization power source line INI is carried out one row at a time. Accordingly, not only do the organic EL element OLEDs emit light in sequence one row at a time, but the black insertion (the organic EL element OLEDs being extinguished) is also carried out in sequence one row at a time. As such, the duration of the light emitting period is the same for all rows, as indicated in FIG. 10. The moving picture performance can be improved as a result, without a drop in display quality.

Furthermore, according to the present embodiment, the black insertion period is provided (i.e., the light emitting period is shorter than in the related art), and thus the amount of drive current for causing the organic EL element OLEDs to emit light is lower than in the related art. Accordingly, the occurrence of uneven luminance, caused by a voltage drop in the high-level power source voltage ELVDD for driving the organic EL element OLEDs, is suppressed. Furthermore, the light emitting period is shorter than in the related art, and thus the occurrence of image sticking is suppressed.

### 1.6 Modification

In the above-described first embodiment, the configuration illustrated in FIG. 5, including six thin film transistors, is employed as the configuration of the pixel circuit 62. However, the configuration is not limited thereto. An example in which a pixel circuit 62 including seven thin film transistors is employed will be described next as a modification of the above-described first embodiment.

FIG. 11 is a circuit diagram illustrating the configuration of the pixel circuit 62 corresponding to the mth column and the nth row, according to the present modification. The pixel circuit 62 illustrated in FIG. 11 includes one organic EL element OLED, seven transistors T1 to T7 (the driving transistor T1, the write control transistor T2, the power supply control transistor T3, the light emission control transistor T4, the threshold voltage compensation transistor T5, the initialization transistor T6, and an anode control transistor T7), and one capacitor C1. The transistors T1 to T7 are p-channel thin film transistors.

As can be seen from FIGS. 5 and 11, in the present modification, the anode control transistor T7 is provided in the pixel circuit 62 in addition to the constituent elements of the above-described first embodiment. With respect to the anode control transistor T7, the gate terminal is connected to the scanning signal line G(n) in the nth row, the source terminal is connected to the anode terminal of the organic EL element OLED, and the above-described initialization voltage Vini_L is supplied to the drain terminal.

In this configuration, the data lines S(1) to S(i), the scanning signal lines G(1) to G(j), the light emission control lines EM(1) to EM(j), and the initialization power source lines INI(1) to INI(j) are driven in the same manner as in the above-described first embodiment. Accordingly, in each of the pixel circuits 62, the anode control transistor T7 is on in a period where the corresponding scanning signal G is at low level (in FIG. 6, the period from time t3 to t4). As a result, an anode voltage of the organic EL element OLED is initialized on the basis of the initialization voltage Vini_L. Accordingly, the level of the anode voltage immediately before the start of light emission in each frame is constant, regardless of the luminance of the light emitted in the previous frame. The display quality is improved as a result.

### 2. Second Embodiment

A second embodiment will be described next. In the above-described first embodiment, the control of the initialization power source line INI is carried out one row at a time. In other words, the voltage for black display Vini_H is temporarily supplied to the j initialization power source lines INI(1) to INI(j) one at a time in sequence. As opposed to this, in the present embodiment, the j initialization power source lines INI(1) to INI(j) are grouped into a plurality of groups, and the control of the initialization power source lines INI is carried out one group at a time. In other words, the voltage for black display Vini_H is applied to the initialization power source lines INI one group at a time. This will be described in detail next.

### 2.1 Configuration and Driving Method of Initialization Power Source Lines

The overall configuration and the configuration of the pixel circuits 62 are the same as in the above-described first embodiment, and thus descriptions thereof will be omitted (see FIGS. 2 and 5). A configuration using seven thin film transistors T1 to T7, such as that illustrated in FIG. 11, can also be employed as the configuration of the pixel circuits 62. Differences from the above-described first embodiment will mainly be described below.

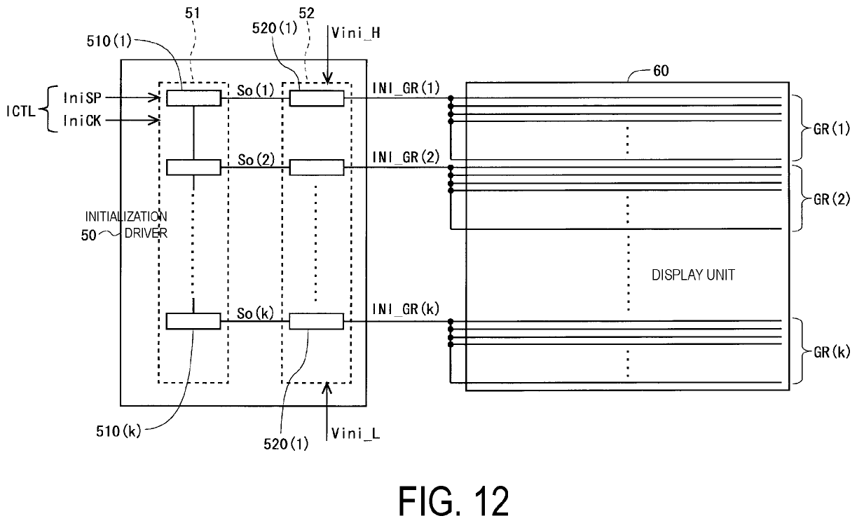

FIG. 12 is a block diagram illustrating the configuration of the initialization driver 50 and the grouping of the initialization power source lines INI according to the present embodiment. In the present embodiment, the j initialization power source lines INI(1) to INI(j) are grouped into k groups GR(1) to GR(k). One group contains several to several tens of initialization power source lines INI. The plurality of initialization power source lines included in each of the k groups GR(1) to GR(k) branch from initialization power source trunk lines INI_GR(1) to INI_GR(k). Because the initialization power source lines INI(1) to INI(j) are grouped in this manner, the initialization driver 50 according to the present embodiment includes a shift register 51 including k stages and a selection circuit group 52 including k selection circuits 520(1) to 520(k), as illustrated in FIG. 12. Output signals So(1) to So(k), outputted from the unit circuits 510(1) to 510(k), are supplied to corresponding ones of the selection circuits 520(1) to 520(k). The selection circuits 520(1) to 520(k) are connected to the initialization power source lines included in corresponding ones of the groups GR(1) to GR(k) via corresponding ones of the initialization power source trunk lines INI_GR(1) to INI_GR(k).

In the configuration described above, an initialization start pulse signal IniSP and an initialization clock signal IniCK are inputted to the shift register 51 as the initialization driver control signal ICTL. The shift register 51 sequentially transfers the pulse of the initialization start pulse signal IniSP from the unit circuit 510(1) in the first stage to the unit circuit 510(k) in the kth stage on the basis of the initialization clock signal IniCK. In response to this pulse transfer, the output signals So(1) to So(k) outputted from each stage of the shift register 51 (the unit circuits 510(1) to 510(k)) go to high level in sequence every predetermined period. The voltage for black display Vini_H is applied to the initialization power source trunk lines INI_GR(1) to INI_GR(k) in sequence one at a time. The initialization power source lines belonging to each group are connected to the initialization power source trunk lines INI_GR(1) to INI_GR(k), and thus the voltage for black display Vini_H is supplied to the j initialization power source lines INI(1) to INI(j), one group at a time in sequence, in accordance with the order in which the organic EL element OLEDs in the i column×j row pixel matrix are to emit light. In this manner, in the present embodiment as well, the voltage for black display Vini_H is supplied to the initialization power source lines INI(1) to INI(j) instead of the initialization voltage Vini_L in a period corresponding to part of each frame period, i.e., temporarily.

The pulsewidth of the initialization clock signal IniCK is set to be longer than in the above-described first embodiment, for example, so that the duration of a period between the timing at which the voltage for black display Vini_H is supplied to the initialization power source trunk lines corresponding to a given group and the timing at which the voltage for black display Vini_H is supplied to the initialization power source trunk lines corresponding to the group following thereafter is an adequate duration.

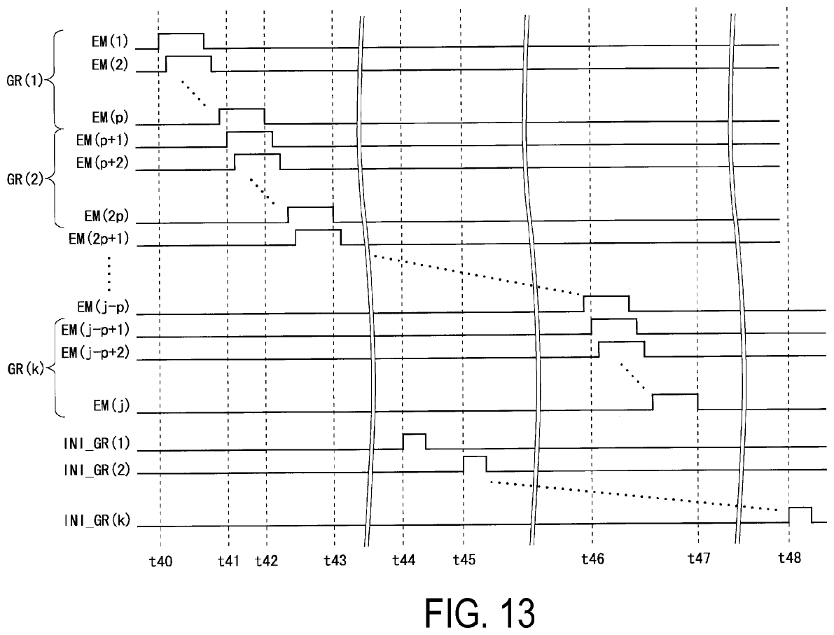

FIG. 13 is a timing chart illustrating a driving method according to the present embodiment. It is assumed here that the j initialization power source lines INI(1) to INI(j) are grouped every p lines. As illustrated in FIG. 13, the light emission control signals EM(1) to EM(j) rise and fall in sequence, one row at a time, in the period from time t40 to t47. Focusing on the light emission control signals EM(1) to EM(p) corresponding to the initialization power source lines INI(1) to INI(p) in the first group GR(1), those rises and falls occur in the period from time t40 to t42. Additionally, focusing on the light emission control signals EM(p+1) to EM(2p) corresponding to the initialization power source lines INI(p+1) to INI(2p) in the second group GR(2), those rises and falls occur in the period from time t41 to t43.

At time t44, the voltage for black display Vini_H is supplied to the initialization power source trunk line INI_GR(1). Accordingly, in each of the pixel circuits 62 in the row corresponding to the first group GR(1) (i.e., the pixel circuits 62 in the first to pth rows), the driving transistor T1 is off. As a result, in each of the pixel circuits 62 in the rows corresponding to the first group GR(1), the supply of the drive current to the organic EL element OLED stops and the organic EL element OLED is extinguished. Likewise, at time t45, the voltage for black display Vini_H is supplied to the initialization power source trunk line INI_GR(2), and as a result, the organic EL element OLED is extinguished in each of the pixel circuits 62 in the rows corresponding to the second group GR(2) (i.e., the pixel circuits 62 in the (p+1)th to 2pth rows).

In the period from time t46 to t47, the light emission control signals EM(j−p+1) to EM(j) rise and fall in sequence one row at a time, and then at time t48, the voltage for black display Vini_H is supplied to the initialization power source trunk line INI_GR(k). Accordingly, in each of the pixel circuits 62 in the row corresponding to the kth group GR(k) (i.e., the pixel circuits 62 in the (j−p+1)th to jth rows), the driving transistor T1 is off. As a result, in each of the pixel circuits 62 in the rows corresponding to the kth group GR(k), the supply of the drive current to the organic EL element OLED stops and the organic EL element OLED is extinguished.

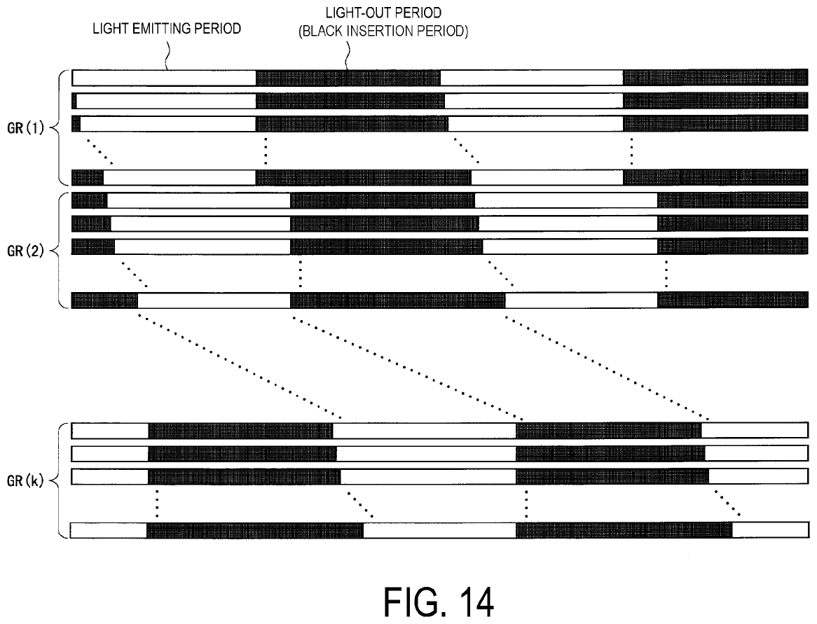

In this manner, according to the present embodiment, the organic EL element OLEDs emit light one row at a time in sequence, but the organic EL elements are extinguished (black insertion) in sequence one group at a time. Accordingly, the overall transitions between the light emitting periods and the light-out periods are as illustrated in FIG. 14. Focusing on each group, the duration of the light emitting period differ between the first row in a group and the last row in the group. However, as long as an adequate duration can be ensured for the light emitting periods, the duration of the light emitting periods from row to row will have less influence on the display quality.

### 2.2 Effects

According to the present embodiment, the light emitting periods and the light-out periods (the black insertion periods) are repeated in an alternating manner in each of the pixel circuits 62, in the same manner as in the above-described first embodiment, and thus the moving picture performance can be improved as compared to the related art. Additionally, according to the present embodiment, the initialization power source lines INI(1) to INI(j) are grouped into a plurality of groups. Accordingly, the application of the voltage for black display Vini_H to the initialization power source lines INI(1) to INI(j) may be carried out one group at a time, and thus the number of stages in the circuits constituting the initialization driver 50 (the shift register 51 and the selection circuit group 52) can be reduced as compared to the above-described first embodiment (see FIG. 12). The circuit scale can thus be reduced, thus achieving the effects of miniaturization and cost-reduction.

### 2.3 Modification

In the above-described second embodiment, the initialization power source lines INI(1) to INI(j) are grouped. However, a configuration in which all of the initialization power source lines INI(1) to INI(j) are grouped into a single group, i.e., all of the initialization power source lines INI(1) to INI(j) are driven in the same manner, can be employed as well. Such a configuration will be described hereinafter as a modification of the above-described second embodiment.

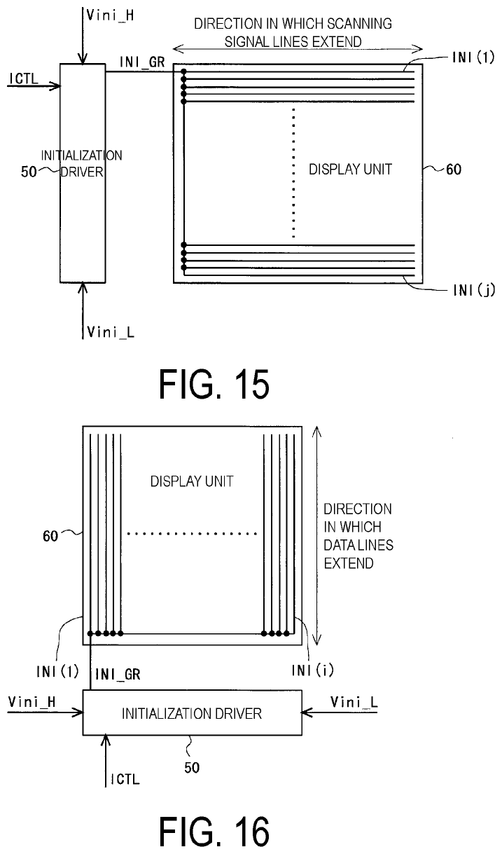

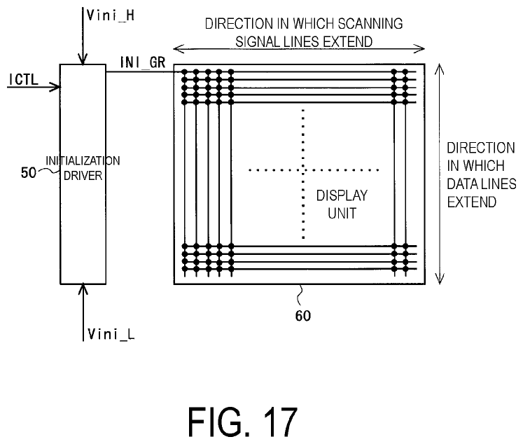

In the present modification, the initialization power source lines INI are configured such that the same voltage is applied to the drain terminal of the initialization transistor T6 in all of the pixel circuits 62 in the display unit 60. The following can be given as specific examples of such a configuration: one signal is supplied from the initialization driver 50, via a one initialization power source trunk line INI_GR, to the j initialization power source lines INI(1) to INI(j) provided corresponding one-to-one with the j scanning signal lines G(1) to G(j) (see FIG. 15); one signal is supplied from the initialization driver 50, via one initialization power source trunk line INI_GR, to the i initialization power source lines INI(1) to INI(i) provided corresponding one-to-one with the i data lines S(1) to S(i) (see FIG. 16); and one signal is supplied from the initialization driver 50, via one initialization power source trunk line INI_GR, to the j initialization power source lines provided corresponding one-to-one with the j scanning signal lines G(1) to G(j) and to the i initialization power source lines provided corresponding one-to-one to the i data lines S(1) to S(i) (see FIG. 17). In this case, the interior of the initialization driver 50 may be configured in the same manner as the selection circuit illustrated in FIG. 4, and the initialization driver control signal ICTL, which goes to high level only in the period when the voltage for black display Vini_H is to be supplied to the initialization power source trunk line INI_GR, may be supplied to the initialization driver 50.

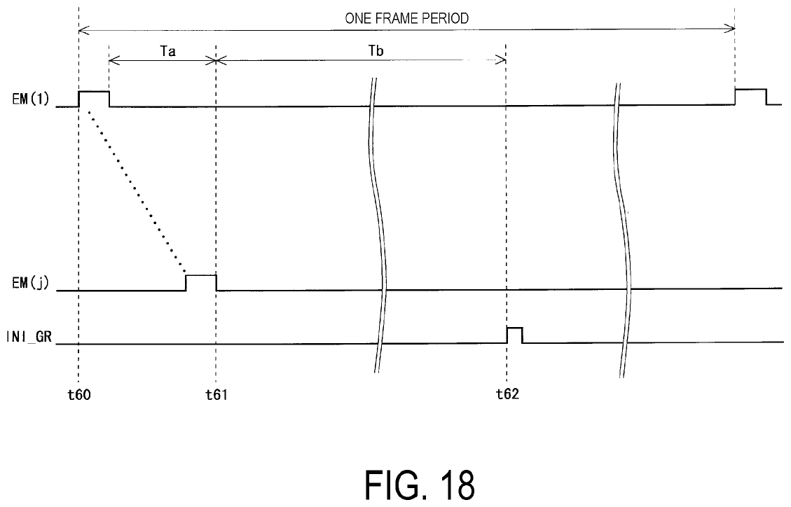

FIG. 18 is a timing chart illustrating a driving method according to the present modification. In each frame period, first, in the period from time t60 to t61, the rise and fall of the light emission control signals EM(1) to EM(j) are carried out in sequence one row at a time.

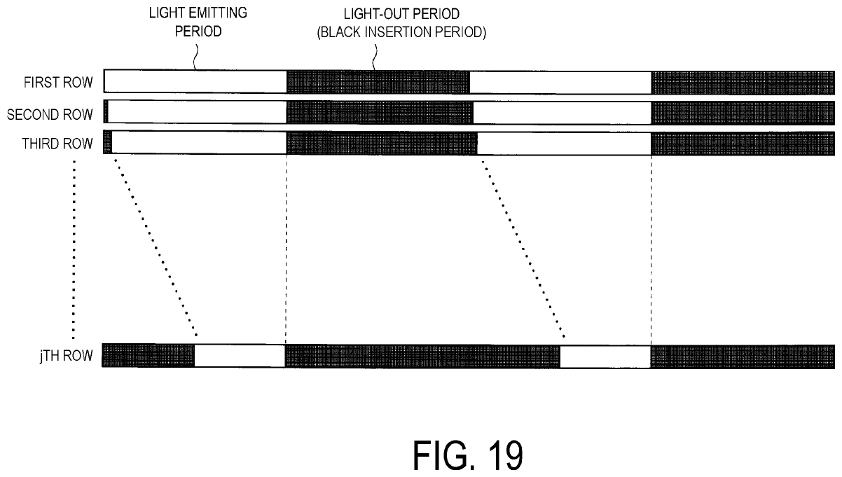

The organic EL element OLEDs start emitting light in sequence, one row at a time, as a result. Then, at time t62, the voltage for black display Vini_H is supplied to the initialization power source trunk line INI_GR. In other words, at time t62, the voltage for black display Vini_H is supplied to all of the initialization power source lines INI. As a result, in all of the pixel circuits 62 in the display unit 60, the supply of the drive current to the organic EL element OLED stops and the organic EL element OLED is extinguished. In this manner, the black insertion is carried out at once for the pixel circuits 62 in all of the rows. Accordingly, the overall transitions between the light emitting periods and the light-out periods are as illustrated in FIG. 19.

Incidentally, according to the present modification, a major difference arises between the durations of the light emitting periods in the pixel circuits 62 in the first row and the pixel circuits 62 in the jth row. However, as long as an adequate duration is ensured for the light emitting periods, or to rephrase, as long as the duration of the period indicated by the reference sign Tb in FIG. 18 is adequately longer than the duration of the period indicated by the reference sign Ta in FIG. 18, the durations of the light emitting period in each of the rows will have less influence on the display quality.

As described thus far, in the present modification, the initialization power source lines INI are configured such that the same voltage is applied to the drain terminal of the initialization transistor T6 in all of the pixel circuits 62 in the display unit 60. The voltage for black display Vini_H is then supplied to the initialization power source lines INI after a predetermined period has passed from the point in time when the light emission control transistors T4, included in the pixel circuits 62 in the last of the plurality of rows of the pixel matrix in terms of the order in which the organic EL element OLEDs emit light, change from off to on. Note that this predetermined period is preferable a period in which an adequate luminance can be ensured in the last row in terms of the order in which the organic EL element OLEDs emit light.

According to the present modification, the application of the voltage for black display Vini_H to all of the pixel circuits 62 via the initialization power source lines INI may be carried out at one time, and thus the configuration of the initialization driver 50 can be made simpler than that in the above-described second embodiment. The circuit scale can be drastically reduced as a result, making it possible to achieve a greater level of miniaturization and lower power consumption than in the above-described second embodiment.

### 3. Other

Although the foregoing embodiments describe an organic EL display device as an example, the type of the display device is not particularly limited as long as it is a display device including electro-optical elements. The above-described electro-optical elements are electro-optical elements in which the luminance, transmittance, and the like are controlled by current. EL display devices such as an organic Electro Luminescence (EL) display device including Organic Light Emitting Diodes (OLEDs) or an inorganic EL display device including inorganic light emitting diodes, a QLED display device including Quantum dot Light Emitting Diodes (QLEDs), and the like can be given as examples of display devices including electro-optical elements controlled by current.

### REFERENCE SIGNS LIST

6 Organic EL panel
10 Display control circuit
20 Source driver
30 Gate driver
40 Emission driver
50 Initialization driver
60 Display unit
62 Pixel circuit
C1 Capacitor
T1 Driving transistor
T2 Write control transistor
T3 Power supply control transistor
T4 Light emission control transistor
T5 Threshold voltage compensation transistor
T6 Initialization transistor
T7 Anode control transistor
INI Initialization power source line
Vini_H Voltage for black display
Vini_L Initialization voltage

1. A display device including a plurality of data lines, a plurality of scanning signal lines arranged intersecting with the plurality of data lines, a plurality of pixel circuits provided corresponding to points of intersection between the plurality of data lines and the plurality of scanning signal lines and forming a pixel matrix having a plurality of rows and a plurality of columns, a plurality of light emission control lines provided corresponding one-to-one with the plurality of scanning signal lines, a first power source line through which a high-level voltage is supplied, and a second power source line through which a low-level voltage is supplied, the display device comprising:
a plurality of initialization power source lines through which an initialization voltage for initializing the pixel circuits is supplied; and
an initialization power source line driving unit configured to drive the plurality of initialization power source lines,
wherein each of the plurality of pixel circuit includes:
a control node;
an electro-optical element, the electro-optical element being provided between the first power source line and the second power source line;
a driving transistor, the driving transistor including a control terminal connected to the control node and being provided between the first power source line and the second power source line in series with the electro-optical element;
a write control transistor, the write control transistor including a control terminal connected to a corresponding scanning signal line and configured to supply, to the control node, a voltage based on the data signal supplied to a corresponding data line;
a light emission control transistor, the light emission control transistor including a control terminal connected to a corresponding light emission control line and being provided between the first power source line and the second power source line in series with the electro-optical element and the driving transistor;
a capacitance element configured to hold a charge based on a voltage at the control node; and
an initialization transistor, the initialization transistor being provided between a corresponding initialization power source line and the control node, and
during a period in which the light emission control transistor in each of the plurality of pixel circuits is being kept on, the initialization power source line driving unit is configured to temporarily supply, to a corresponding initialization power source line, a voltage for black display instead of the initialization voltage, the voltage for black display being a voltage at a level that turns the initialization transistor on and turns the driving transistor off.

2. The display device according to claim 1,
wherein the plurality of initialization power source lines are provided corresponding one-to-one with the plurality of scanning signal lines; and
the initialization power source line driving unit supplies the voltage for black display to the plurality of initialization power source lines sequentially, one line at a time, according to an order in which the electro-optical elements emit light in the pixel matrix.

3. The display device according to claim 1,
wherein the plurality of initialization power source lines are grouped into a plurality of groups; and
the initialization power source line driving unit supplies the voltage for black display to the plurality of initialization power source lines sequentially, one group at a time, according to an order in which the electro-optical elements emit light in the pixel matrix.

4. The display device according to claim 1,
wherein the plurality of initialization power source lines are configured to supply a same voltage to all of the plurality of pixel circuits; and
the initialization power source line driving unit supplies the voltage for black display to the plurality of initialization power source lines after a predetermined period has passed from a point in time when the light emission control transistors of the plurality of pixel circuits in a row, among a plurality of rows of the pixel matrix, that is last in terms of an order in which the electro-optical elements emit light, have changed from off to on.

5. The display device according to claim 1,
wherein the initialization power source line driving unit supplies the voltage for black display to the initialization power source line corresponding to each pixel circuit such that the electro-optical element in that pixel circuit stops emitting light for a period equivalent to ½ or more of one frame period.

6. The display device according to claim 1,
wherein the initialization transistor includes a p-channel thin film transistor including a control terminal connected to a corresponding scanning signal line in a row one or more rows previous, a first conduction terminal being connected to the control node, and a second conduction terminal being connected to a corresponding initialization power source line; and
the voltage for black display is set to a level greater than a voltage corresponding to a sum of a voltage supplied to the scanning signal line and a threshold voltage of the initialization transistor such that the write control transistor is kept off.

7. The display device according to claim 1,
wherein each pixel circuit further includes:
a power supply control transistor, the power supply control transistor including a control terminal connected to a corresponding light emission control line, a first conduction terminal connected to the first power source line, and a second conduction terminal connected to a first conduction terminal of the driving transistor;
a threshold voltage compensation transistor, the threshold voltage compensation transistor including a control terminal connected to a corresponding scanning signal line, a first conduction terminal connected to a second conduction terminal of the driving transistor, and a second conduction terminal connected to the control node; and
a capacitor, and
in each pixel circuit:
an anode terminal of the electro-optical element is connected to a second conduction terminal of the light emission control transistor;
a cathode terminal of the electro-optical element is connected to the second power source line;
one electrode of the capacitor is connected to the first power source line;
another electrode of the capacitor is connected to the control node;
a first conduction terminal of the write control transistor is connected to a corresponding data line;
a second conduction terminal of the write control transistor is connected to the first conduction terminal of the driving transistor;
a first conduction terminal of the light emission control transistor is connected to the second conduction terminal of the driving transistor;
a control terminal of the initialization transistor is connected to a corresponding scanning signal line in a row one or more rows previous;
a first conduction terminal of the initialization transistor is connected to the control node; and
a second conduction terminal of the initialization transistor is connected to a corresponding initialization power source line.

8. The display device according to claim 7,
wherein the driving transistor, the write control transistor, the power supply control transistor, the light emission control transistor, the threshold voltage compensation transistor, and the initialization transistor include p-channel thin film transistors.

9. The display device according to claim 7,
wherein each of the plurality of pixel circuit further includes an anode control transistor, the anode control transistor including a control terminal connected to a corresponding scanning signal line, a first conduction terminal to which the initialization voltage is supplied, and a second conduction terminal connected to an anode terminal of the electro-optical element.

10. A driving method for a pixel circuit of a display device, the display device including:
a plurality of data lines;
a plurality of scanning signal lines arranged intersecting with the plurality of data lines;
a plurality of pixel circuits provided corresponding to points of intersection between the plurality of data lines and the plurality of scanning signal lines and forming a pixel matrix having a plurality of rows and a plurality of columns;
a plurality of light emission control lines provided corresponding one-to-one with the plurality of scanning signal lines;
a first power source line through which a high-level voltage is supplied;
a second power source line through which a low-level voltage is supplied; and
a plurality of initialization power source lines through which an initialization voltage for initializing the pixel circuits is supplied,
wherein each pixel circuit includes:
a control node;
an electro-optical element, the electro-optical element being provided between the first power source line and the second power source line;
a driving transistor, the driving transistor including a control terminal connected to the control node and being provided between the first power source line and the second power source line in series with the electro-optical element;
a write control transistor, the write control transistor including a control terminal connected to a corresponding scanning signal line and configured to supply, to the control node, a voltage based on the data signal supplied to the corresponding data line;
a light emission control transistor, the light emission control transistor including a control terminal connected to a corresponding light emission control line and being provided between the first power source line and the second power source line in series with the electro-optical element and the driving transistor;
a capacitance element configured to hold a charge based on a voltage at the control node; and
an initialization transistor, the initialization transistor including a control terminal connected to a corresponding scanning signal line in a row one or more rows previous and being provided between a corresponding initialization power source line and the control node,
the driving method comprising:
supplying the initialization voltage to the control node by supplying an on-level voltage to the scanning signal line connected to the control terminal of the initialization transistor and turning the initialization transistor on;
supplying, to the control node, a voltage based on a data signal supplied to a corresponding data line, by supplying an on-level voltage to a corresponding scanning signal line and turning the write control transistor on;
causing the electro-optical element to emit light by supplying an on-level voltage to a corresponding light emission control line and turning the light emission control transistor on; and
during a period in which the light emission control transistor is being kept on, temporarily supplying, to a corresponding initialization power source line, a voltage for black display instead of the initialization voltage, the voltage for black display being a voltage at a level that turns the initialization transistor on and turns the driving transistor off.
